(19) United States
(12) Patent Application Publication
(10) Pub. No.: US 2026/0319587 A1
(43) Pub. Date: Oct. 15, 2026

(54) CONTROL DEVICE CAPABLE OF REALIZING FEEDBACK OF PSEUDO HAPTIC SENSATION, PLAYBACK DEVICE, IMAGE CAPTURING APPARATUS, METHOD OF CONTROLLING CONTROL DEVICE, AND STORAGE MEDIUM

(71) Applicant: CANON KABUSHIKI KAISHA, Tokyo (JP)

(72) Inventor: TETSUYA HATA, Kanagawa (JP)

(21) Appl. No.: 19/574,930

(22) Filed: Mar. 23, 2026

(30) Foreign Application Priority Data
Apr. 15, 2025 (JP) 2025-066835

(51) Int. Cl. G06F 3/01; G06V 20/40; H04N 23/61; H04N 23/62; H04N 23/67; H04N 23/71; G06V 40/20

(52) U.S. Cl. CPC G06F 3/016; G06V 20/42; H04N 23/61; H04N 23/62; H04N 23/675; H04N 23/71; G06V 40/23

(57) ABSTRACT

A control device capable of realizing feedback of pseudo haptic sensation for enhancing the realism of a video. In a case where a first object and a second object which higher in precedence than the first object are included in a frame of a video signal, the control device makes pseudo haptic sensation fed back to a user according to the second object stronger than pseudo haptic sensation fed back to the user according to the first object.

### BACKGROUND

### Field of the Technology

The present disclosure relates to a control device capable of realizing feedback of pseudo haptic sensation, a playback device, an image capturing apparatus, a method of controlling the control device, and a storage medium.

### Description of the Related Art

Conventionally, a haptic device is known as a technology that feeds back haptic sensation to a user by controlling vibration and temperature of the haptic device. Therefore, a haptic device connected to a display device, a controller or the like is capable of enhancing the realism of video by feeding back haptic sensation according to the content of the video to a user experiencing the video. PCT International Patent Publication No. 2019/038888 proposes a related technology that vibrates a vibration mechanism according to a position of an object of interest appearing in the video presented to the user.

Incidentally, to enhance the realism of video by the haptic sensation, it is important to adjust the haptic sensation which the haptic device feeds back to a user to relative positioning of each object appearing in the video. In this respect, even though objects are of the same type, the relative positioning of each object is different depending on a situation in which the object appears in the video. For this reason, it is demanded that the haptic device feeds back the haptic sensation to the user according to relative positioning of each object when the object appears in the image. However, the technology described in PCT International Patent Publication No. 2019/038888 is difficult in realizing such feedback of haptic sensation, and hence there sometimes arises a sense of incongruity between the relative positioning of each object appearing in the video and the haptic sensation being fed back to a user.

### SUMMARY

The present disclosure is directed to providing a control device capable of realizing feedback of pseudo haptic sensation for enhancing the realism of video, a playback device, an image capturing apparatus, a method of controlling the control device, and a storage medium.

In a first aspect of the present disclosure, there is provided a control device that, in a case where a first object and a second object which higher in precedence than the first object are included in a frame of a video signal, makes pseudo haptic sensation fed back to a user according to the second object stronger than pseudo haptic sensation fed back to the user according to the first object.

In a second aspect of the present disclosure, there is provided a control device including at least one processor, and a memory storing instructions that, when executed by the at least one processor, causes the at least one processor to function as: a first generation unit configured to generate haptic information used when a haptic device feeds back pseudo haptic sensation to a user, for each of objects included in the video signal, a second generation unit configured to generate object precedence information indicating precedence of each of the objects included in the video signal, for each frame of the video signal, and a first control unit configured to control haptic information generated by the first generation unit according to object precedence information generated by the second generation unit,

wherein the first control unit makes pseudo hepatic sensation fed back to a user by the haptic device by using haptic information corresponding to a second object higher in precedence than a first object stronger than pseudo hepatic sensation fed back to the user by the haptic device by using haptic information corresponding to the first object.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram showing an example of a configuration of a video experience system according to a first embodiment.

FIG. 2 is a block diagram showing an example of a configuration of an image capturing apparatus.

FIG. 3 is a block diagram showing an example of a functional configuration of an image processor of the image capturing apparatus.

FIGS. 4A to 4D are diagrams useful in explaining a method of generating haptic information, a method of generating object precedence information, and a method of controlling haptic information according to the object precedence information.

FIG. 5 is a flowchart of a control process for controlling the operation of the image capturing apparatus.

FIG. 6 s a block diagram showing an example of a configuration of a playback device.

FIG. 7 is a block diagram showing an example of a configuration of a playback device according to a second embodiment.

FIG. 8 is a block diagram showing an example of a functional configuration of a video signal processor of the playback device.

FIG. 9 is a flowchart a control process for controlling the operation of the playback device.

### DESCRIPTION OF THE EMBODIMENTS

The present disclosure will now be described in detail below with reference to the accompanying drawings showing embodiments thereof. Configurations described in the embodiments are described only by way of example, and by no means limit the scope of the disclosure. For example, components of the configurations can be replaced with desired components which can exhibit the same functions. Further, desired components can be added. Further, in the following embodiments, desired two or more components (features) can be combined.

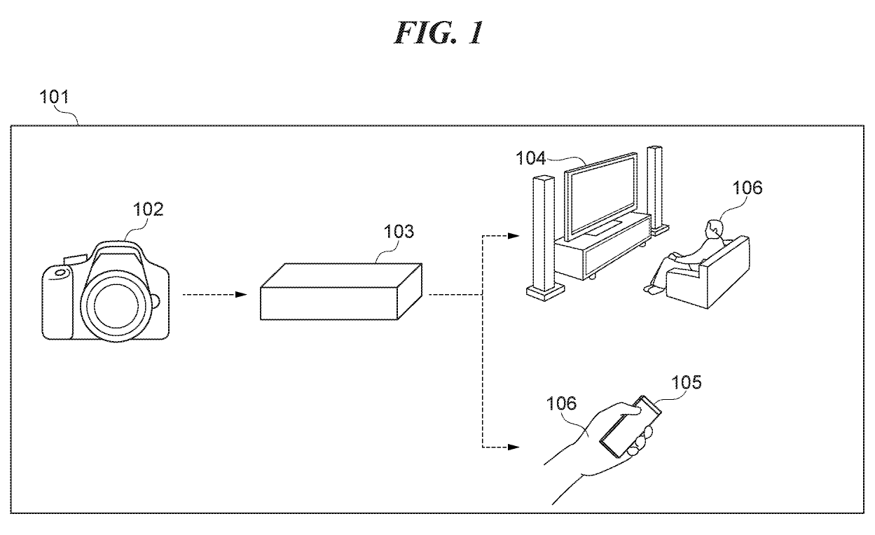

In the first embodiment, when a signal of video (hereinafter referred to as “video signal”) is generated in the image capturing apparatus, haptic information is generated for each object appearing in the video, and object precedence information is generated for each frame of the video signal. Further, haptic information controlled according to the object precedence information is stored in a form added to the video signal. Note that in the first embodiment, the video refers to a plurality of images formed by a moving image or still images. Hereafter, a first embodiment will be described with reference to FIGS. 1-6.

FIG. 1 is a diagram showing an example of a configuration of a video experience system 101. The video experience system 101 includes an image capturing apparatus 102 and a playback device 103. The image capturing apparatus 102 records a video signal and haptic information, as described above. Note that details of the haptic information will be described hereinafter. The video signal and the haptic information recorded by the image capturing apparatus 102 are output to the playback device 103 via a recording medium (described hereinafter) and a network (not shown). To the playback device 103, a display device 104 and a haptic device 105 are wired or wireless connected. The playback device 103 causes the display device 104 to display the video signal recorded by the image capturing apparatus 102 and the haptic device 105 to present the haptic information recorded by the image capturing apparatus 102. This causes the video experience system 101 to reproduce video.

Note that the image capturing apparatus 102 is a digital camera, but can be a laptop-type personal computer (PC), a smartphone, or a camera-equipped mobile terminal, such as a tablet. Further, the playback device 103 can be, for example, a game controller, a laptop-type personal computer, or a mobile terminal, such as a smartphone, or a tablet, or can be a desktop-type personal computer.

Reference numeral 106 denotes a user who experiences video in the video experience system 101. The haptic device 105 feeds back pseudo haptic sensation based on the haptic information to the user 106. The haptic device 105 feeds back the pseudo haptic sensation to the user 106, by causing a vibration presenting device (not shown), such as a linear resonance actuator (LRA) or a piezoelectric actuator, to vibrate with a specific waveform. Note that the haptic device 105 can feed back the pseudo haptic sensation to the user 106 by causing a specific temperature to be sensed by a temperature presenting device, such as a Peltier device or a heater.

Further, in FIG. 1, the user 106 experiences the video by holding the haptic device 105 by hand. In this respect, the haptic device 105 can be one which is worn around a wrist or an ankle. More specifically, the haptic device 105 can have any configuration insofar as it can feed back the pseudo haptic sensation based on the input haptic information to the user 106. Note that the display device 104 and the haptic device 105 can be configured to be unified by being mounted on a head mount display (HMD).

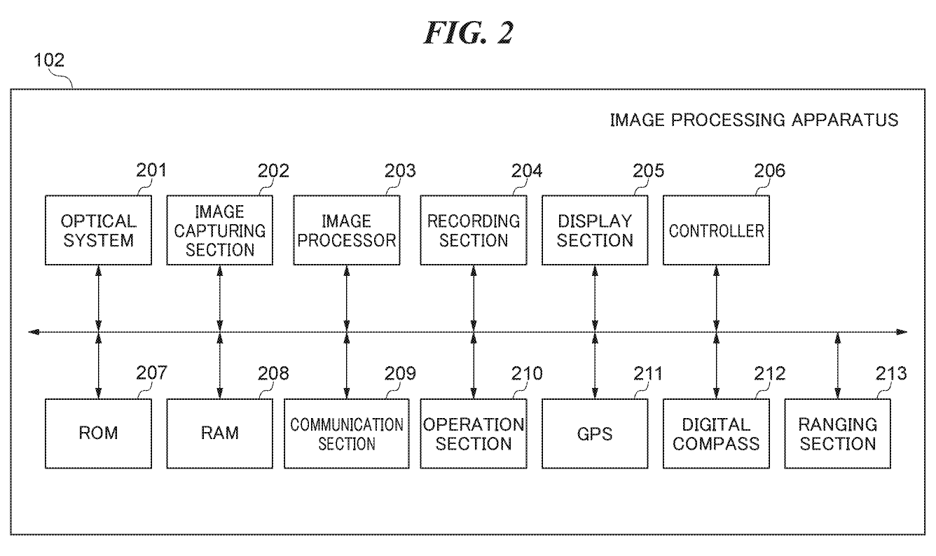

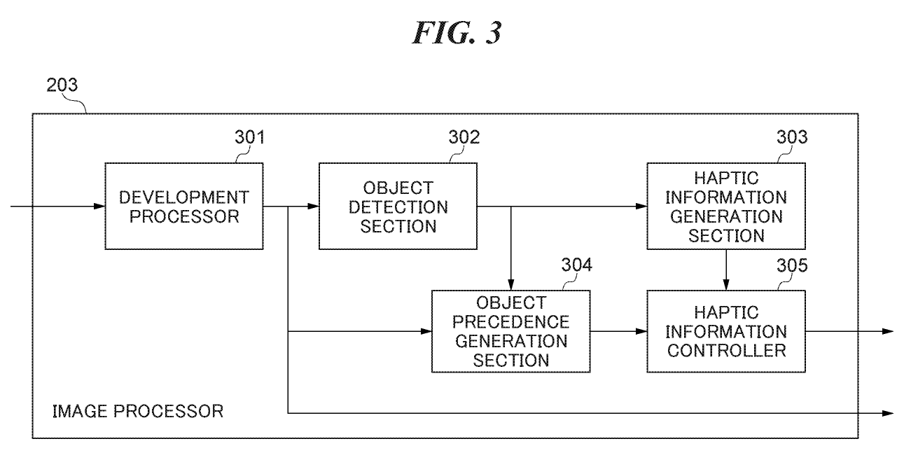

Next, the image capturing apparatus 102 will be described with reference to FIGS. 2 and 3. FIG. 2 is a block diagram showing an example of a configuration of the image capturing apparatus 102. The image capturing apparatus 102 includes an optical system 201, an image capturing section 202, an image processor 203, a recording section 204, a display section 205, a controller 206, a read only memory (ROM) 207, a random access memory (RAM) 208, a communication section 209, an operation section 210, a global positioning system (GPS) 211, a digital compass 212, and a ranging section 213. The optical system 201 is formed by a lens group (not shown) including a zoom lens and a focus lens, and the like, and forms an object image on an imaging surface of the image capturing section 202. The optical system 201 includes an operation section (not shown) on which an operator of the image capturing apparatus 102 performs a direct operation for controlling a zoom position and a focus position.

The image capturing apparatus 202 is, for example, an image sensor, such as a charge coupled device (CCD), a complementary metal oxide semiconductor (CMOS) sensor or the like. The image capturing apparatus 202 photoelectrically converts an optical image formed on the imaging surface by the optical system 201 to analog image data, and the analog image data is converted by an analog-to-digital (A/D) converter (not shown) to digital image data, which is output as RAW image data. The RAW image data output from the image capturing section 202 is temporarily stored in the RAM 208. The image processor 203 performs development processing on the RAW image data stored in the RAM 208 and processing related to haptic information. Note the functional configuration and details of processing of the image processor 203 will be described hereinafter.

The recording section 204 is a recording medium, such as a removable memory card. In the recording medium 204, a video signal generated by the image processor 203 is recorded via the RAM 208. The display section 205 is a display device, such as a liquid crystal display (LCD). The display section 205 displays image data stored in the RAM 208, the video signal recorded in the recording section 204, an operation user interface for receiving an instruction from an operator of the image capturing apparatus 102, and so forth. The controller 206 is e.g. a central processing unit (CPU). The controller 206 reads out operation programs of blocks included in the image capturing apparatus 102 from the ROM 207, loads the operation programs into the RAM 208, for execution. With this, the controller 206 controls the operations of the blocks of the image capturing apparatus 102.

The ROM 207 is an electrically recordable/erasable non-volatile memory. The ROM 207 stores, in addition to operation programs of blocks included in the image capturing apparatus 102, parameters necessary for the operations of the blocks, and so forth. The RAM 208 is a rewritable volatile memory. The RAM 208 is used for loading programs executed by the controller 206, and the like, and temporarily storing data e.g. generated during operations of the blocks of the image capturing apparatus 102. The communication section 209 communicates with an external apparatus via the above-mentioned network. The operation section 210 includes a touch panel (not shown) and operation buttons (not shown), and inputs an instruction by the operator of the image capturing apparatus 102 to the controller 206. Further, the operation section 210 includes a shutter button (not shown). The operator of the image capturing apparatus 102 is capable of issuing an instruction for performing image capturing by a half-pressing operation or a full-pressing operation on the shutter button, described above, of the operation section 210.

The GPS 211 is a GPS sensor that receives a GPS signal from a GPS satellite, i.e. acquires position information of the image capturing apparatus 102. The digital compass 212 is a magnetic sensor that detects geomagnetism and acquires information on an image capturing direction of the image capturing apparatus 102. The ranging section 213 measures a distance from the image capturing apparatus 102 to each object area serving as a ranging target. The ranging section 213 measures the distance from the image capturing apparatus 102 to the object area, e.g. based on a phase difference detected by focus detection means based on a phase difference detection method and the position information of a lens of the optical system 201.

Next, the functional configuration of the image processor 203 will be described with reference to FIG. 3. FIG. 3 is a block diagram showing an example of a functional configuration of the image processor 203. The image processor 203 includes a development processor 301, an object detection section 302, a haptic information generation section 303, an object precedence generation section 304, and a haptic information controller 305. The development processor 301 generates a video signal by performing white balance adjustment, color interpolation, gamma processing, noise reduction (NR) processing, and so forth on RAW image data stored in the RAM 208. The video signal generated by the development processor 301 is recorded in the recording section 204 via the RAM 208, and is output to the project detection section 302 and the object precedence generation section 304.

The object detection section 302 detects an object included in the video signal generated by the development processor 301. The object detection section 302 outputs information indicating the type of a detected object to the haptic information generation section 303 and outputs information indicating the position and size of a detected object to the object precedence generation section 304.

The haptic information generation section 303 generates haptic information for each object detected by the object detection section 302. The haptic information is data used for the haptic device 105 to feed back pseudo haptic sensation to the user 106. The haptic information is only required to be data indicating vibration of the vibration presentation device included in the haptic device 105, and can be, for example, waveform data itself, or data indicating features of repetition period, amplitude and the like of the waveform data. Note that in a case where haptic device 105 includes the above-described temperature presentation device, the haptic information can be data (hereinafter referred to as “the temperature data”) indicating the temperature presented by the temperature presentation device. In other words, the haptic information can be any format of data, insofar as it is data for feeding back haptic information to the user 106 by the haptic device 105.

The haptic information generation section 303 reads out haptic information corresponding to each object detected by the object detection section 302 from the ROM 207 to thereby generate haptic information on an object-by-object basis. To this end, haptic information, such as waveform data, is stored in the ROM 207 for each typical object, in advance. Note that the haptic information generation section 303 acquires audio signals via a recording section (not shown) of the image capturing apparatus 102 and generates waveform data for pseudo playback of the acquired audio signal by vibration, as haptic information. Hereafter, in the first embodiment, a description will be given of a case in which as the haptic information, waveform data for causing vibration of the vibration presentation device mentioned above which is included in the haptic device 105 is generated. Further, the intensity (amplitude) of each waveform data item stored in the ROM 207 in advance is assumed to be of a standard value. Note that a specific method of generating haptic information will be described hereinafter. The haptic information generation section 303 outputs the generated haptic information to the haptic information controller 305.

The object precedence generation section 304 generates, for each frame of a video signal generated by the development processor 301, object precedence information indicating a precedence of each object based on a size relationship between the objects detected by the object detection section 302. In the first embodiment, it is assumed that in each frame of the video signal, an object larger in size is determined to be higher in precedence than an object smaller in size. Note that a specific method of generating object precedence information will be described hereinafter. The object precedence generation section 304 outputs object precedence information to the haptic information generation section 305.

The haptic information controller 305 controls the haptic information which is waveform data of a standard strength, which is generated by the haptic information generation section 303, according to the object precedence information generated by the object precedence generation section 304. The haptic information controlled by the haptic information controller 305 is recorded in the recording section 204 via the RAM 208.

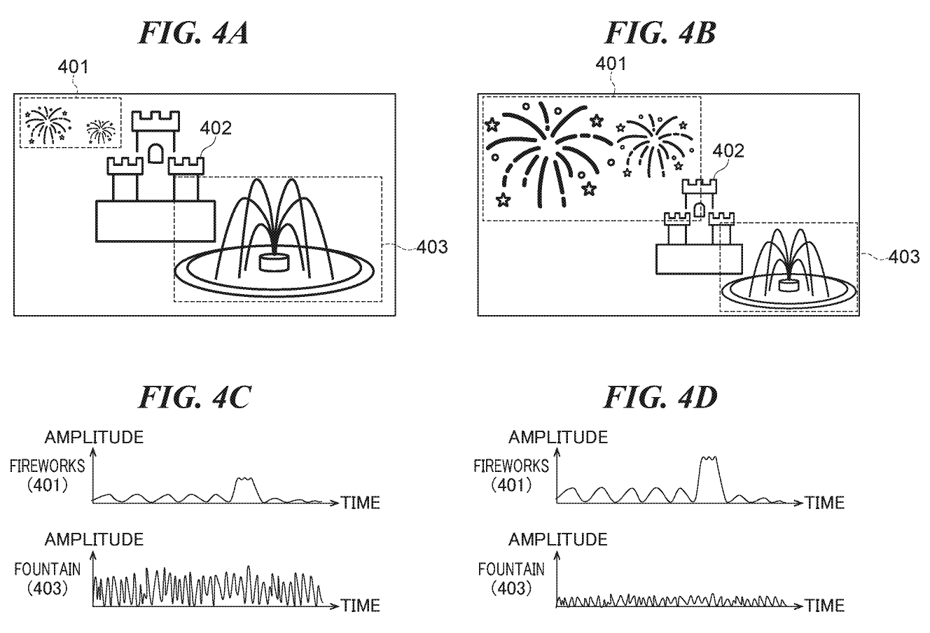

Here, with reference to FIGS. 4A-4D, the method of generating haptic information, the method of generating object precedence information, and the method of controlling the haptic information according to the object precedence information will be described. First, the method of generating haptic information will be specifically described. FIGS. 4A and 4B are diagrams each showing an example of a frame of a video signal when respective images of a plurality of objects are captured each in a different composition. In the case of FIGS. 4A and 4B, the object detection section 302 detects three types of objects, i.e. fireworks 401, a building 402, and a fountain 403.

In these cases, the haptic information generation section 303 generates haptic information corresponding to the fireworks 401 and haptic information corresponding to the fountain 403. Specifically, waveform data for pseudo playback of sound and impact generated when the fireworks 401 are fired into the sky, by vibration caused by the vibration presentation device included in the haptic device 105, is generated as haptic information corresponding to the fireworks 401. Further, waveform data for pseudo playback of sound generated when water from the fountain 403 hits the water surface, by vibrations caused by the vibration presentation device included in the haptic device 105, is generated as haptic information corresponding to the fountain 403.

However, in a case where an object, such as the building 402, detected by the object detection section 302 does not move or does not produce any sound, the haptic information generation section 303 ignores the object. This prevents the haptic information generation section 303 from generating haptic information corresponding to the building 402. This is also the case with the object for which haptic information has not been stored in the ROM 207 in advance, and haptic information corresponding to the object is not generated.

Next, a specific description will be given of a method of generating object precedence information. Here, a case will be described where object precedence information is generated for each frame of the video signal which continuously reproduces compositions shown in FIGS. 4A and 4B. In the case of FIG. 4A, a fountain 403 (second object) appears larger than fireworks 401 (first object). On the other hand, in the case of FIG. 4B, the wireworks 401 (second object) appear larger than the fountain 403 (first object). For this reason, a stronger impression is given from the fountain 403 to the user 106 than from the fireworks 401 in the case of FIG. 4A, and a stronger impression is given from the fireworks 401 to the user 106 than from the fountain 403 in the case of FIG. 4B.

Therefore, if pseudo haptic sensation fed back to the user 106 by the haptic device 105 using haptic information agrees with the strength of impression given from the fireworks 401 and the fountain 403 to the user 106, the realism of the video is enhanced. To this end, in the case of FIG. 4A, it is only required that the strength of waveform data of haptic information corresponding to the fountain 403 is stronger than a standard strength. Alternatively, it is only required that the strength of waveform data of haptic information corresponding to the fireworks 401 is weaker than a standard strength. On the other hand, in the case of FIG. 4B, it is only required that the strength of waveform data of haptic information corresponding to the fireworks 401 is stronger than the standard strength. Alternatively, it is only required that the strength of waveform data of haptic information corresponding to the fountain 403 is weaker than the standard strength.

To realize the control described above, the object precedence generation section 304 generates information indicating a size relationship indicating that the fountain 403 is larger than the fireworks 401 (i.e. the fountain 403 is higher in precedence than the fireworks 401), as object precedence information. Further, the object precedence generation section 304 generates information indicating the size relationship that the size of the fireworks 401 is larger than that of the fountain 403 (i.e. the fireworks 401 are higher in precedence than the fountain 403), as the object precedence information.

Next, a specific description will be given of the method of controlling haptic information according to the object precedence information. The haptic information controller 305 controls the strength of waveform data of haptic information according to the precedence indicated by the object precedence information. FIGS. 4C and 4D show examples of result of control of the strength of waveform data of haptic information according to the precedence indicated by the object precedence information. That is, FIG. 4C is a diagram of an example of waveform data items of respective pieces of haptic information corresponding to the fireworks 401 and the fountain 403, respectively, which are included in respective frames of the video signal in the case where the composition in FIG. 4A continues. Further, FIG. 4D is a diagram of an example of waveform data items of respective pieces of haptic information corresponding to the fireworks 401 and the fountain 403, respectively, which are included in respective frames of the video signal in the case where the composition in FIG. 4B continues. In FIGS. 4C and 4D, the horizontal axis represents time of waveform data, and the vertical axis represents amplitude of the waveform data.

As descried above, in the case of FIG. 4A, the object precedence information is information on the size relationship indicating that the fountain 403 is larger than the fireworks 401 (i.e. that the fountain 403 is higher in precedence than the fireworks 401). In this case, the precedence information controller 305 increases the amplitude of the waveform data of haptic information corresponding to the fountain 403 indicated by the object precedence information as higher in precedence. Alternatively, the precedence information controller 305 decreases the amplitude of the waveform data of haptic information corresponding to the fireworks 401 indicated by the object precedence information as lower in precedence. This makes, in the case of FIG. 4C (i.e. the case of FIG. 4A), the amplitude of waveform data of haptic information corresponding to the fountain 403 larger than that of waveform data of haptic information corresponding to the fireworks 401.

On the other hand, in the case of FIG. 4D, the object precedence information is information on the size relationship indicating that the fireworks 401 are larger than the fountain 403 (i.e. that the fireworks 401 are higher in precedence than the fountain 403). In this case, the precedence information controller 305 increases the amplitude of the waveform data of haptic information corresponding to the fireworks 401 indicated by the object precedence information as higher in precedence. Alternatively, the precedence information controller 305 decreases the amplitude of the waveform data of haptic information corresponding to the fountain 403 indicated by the object precedence information as lower in precedence. This makes, in the case of FIG. 4D (i.e. the case of FIG. 4B), the amplitude of waveform data of haptic information corresponding to the fireworks 401 larger than that of waveform data of haptic information corresponding to the fountain 403.

From the above, in both the cases of FIGS. 4C and 4D, pseudo haptic sensation which the haptic device 105 feeds back to the user 106 by using haptic information is made commensurate with respective impressions given by the fireworks 401 and the fountain 403.

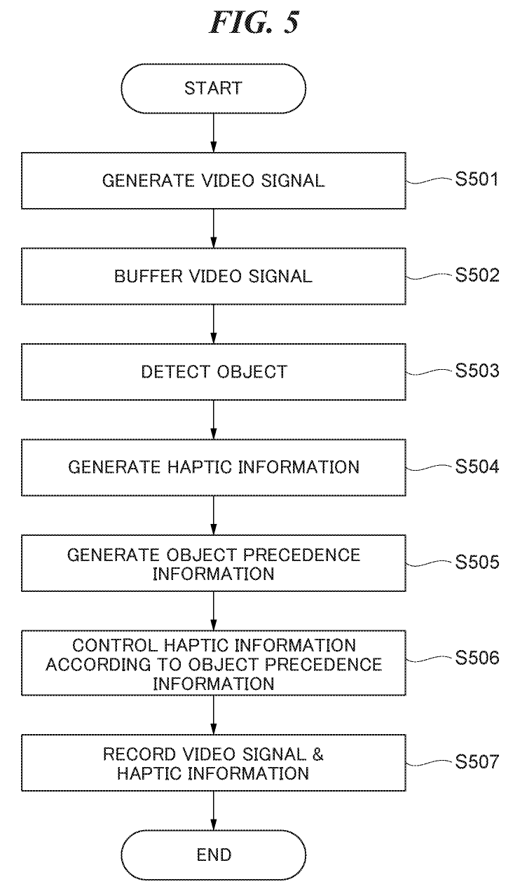

Next, with reference to FIG. 5, the operation of the image capturing apparatus 102 will be described. FIG. 5 is a flowchart of the control process for controlling the operation of the image capturing apparatus 102. The control process (control method of the control device) in FIG. 5 is realized by the controller 206 of the image capturing apparatus 102, loading the program stored in the ROM 207 into the RAM 208 and executing the loaded program. When the control process in FIG. 5 is started, in a step S501, the controller 206 (generation unit) controls the development processor 301 to generate a video signal.

In a step S502, the controller 206 (storage unit) performs buffering of the video signal generated in the step S501 in the RAM 208. In doing this, in a case where the buffer capacity of the RAM 208 is insufficient for image data as a source of the video signal generated in the step S501, the controller 206 performs processing in the step S502 by dividing the image data as the source of the video signal generated in the step S501. More specifically, whenever image data as a source of the video signal generated in the step S501 fulfills a predetermined capacity of the buffer capacity of the RAM 208, the controller 206 performs processing in each of the steps following a step S503, described hereinafter, on the image data as the source of the video signal buffered in the RAM 208. Even when the predetermined capacity of the buffer capacity of the RAM 208 is not filled with image data as the source of the video signal generated in the step S501, such processing is performed in the same manner when the generation of the video signal in the step S501 is completed. This causes the processing in each of the steps following the step S503 to be performed on all image data as a source of the video signal generated in the step S501.

In the step S503, the controller 206 controls the object detection section 302 to perform detection of an object included in the video signal buffered in the step S502. Further, the object detection section 302 outputs information indicating a type of the detected object to the haptic information generation section 303, and information indicating a position and a size of the detected object to the object precedence generation section 304. In a step S504, the controller 206 (first generation unit) generates haptic information corresponding to each of objects detected in the step S503 (first generation).

In a step S505, the controller 206 (second generation unit) controls the object precedence generation section 304 to generate the object precedence information indicating the precedence of each object by the size relationship between the objects detected in the step S503. In doing this, the object precedence generation section 304 performs generation of object precedence information for each frame of the video signal buffered in the step S502 (second generation). In a step S506, the controller 206 (first control unit) controls the haptic information controller 305 to control the haptic information generated in the step S504 according to the object precedence information generated in the step S505 (control). In a step S507, the controller 206 (recording unit) controls the recording section 204 to record the video signal buffered in the step S502 and the haptic information controlled in the step S506 added to the video signal, followed by terminating the control process in FIG. 5.

As described above, in the control process in FIG. 5, the controller 206 performs, after buffering a predetermined volume of the generated video signal (i.e. image data as a source thereof) in the RAM 208, generation of haptic information in the step S504 and control of the haptic information in the step S506. This enables the controller 206 to match the timing of movement of an object in the video signal and the timing of haptic information of the object. Further, the controller 206 is capable of acquiring the timing of the video signal buffered in the RAM 208 at which the size of an object relatively high in precedence becomes the largest. This makes it possible to prevent occurrence of a situation in which before the size of an object relatively high in precedence becomes the largest, the amplitude of waveform data of haptic information corresponding to the object reaches an upper limit.

However, processing in each of the steps following the step S502 can be repeatedly performed whenever each frame of the video signal is generated. In this case, although the controller 206 cannot use each timing mentioned above, it is possible to use a RAM of which the capacity is smaller than the above-mentioned predetermined capacity, as the RAM 208. Further, in the control process in FIG. 5, although the generation of haptic information in the step S504 is performed separately from the control of haptic information in the step S506, it can be performed simultaneously with the control of haptic information.

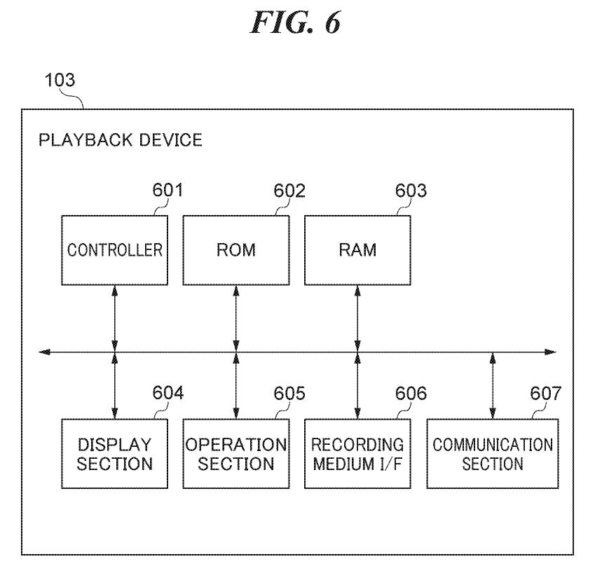

Next, the configuration and operation of the playback device 103. First, the configuration of the playback device 103 will be described. FIG. 6 is a block diagram showing an example of the configuration of the playback device 103. The playback device 103 includes a controller 601, a ROM 602, a RAM 603, a display section 604, an operation section 605, a recording medium interface (I/F) 606, and a communication section 607. The controller 601 reads out an operation program for each block from the ROM 602 and loads the operation program into the RAM 603 to execute the same. With this, the controller 601 controls the operation of each block included in the playback device 103. The ROM 602 is an electrically recordable/erasable non-volatile memory. The ROM 602 stores, in addition to operation programs for the blocks of the playback device 103, parameters necessary for the blocks, and so forth.

The RAM 603 is a rewritable volatile memory. The RAM 603 is used for loading programs executed by the controller 601, and temporarily storing data generated by operations of the blocks of the playback device 603, and the like. The display section 604 is a display device, such as an LCD. The display section 604 performs display of an operation user interface for receiving an instruction from the operator of the playback device 103, and the like. The operation section 605 includes a touch panel (not shown), and inputs an instruction by the operator of the playback device 103 to the controller 601. The recording medium I/F 606 is an interface with the above-described recording medium. The communication section 607 performs communication with external devices, the display device 104, and the haptic device 105 via the above-described network.

Next, the operation of the playback device 103 will be described. In the first embodiment, as described above, the video signal and haptic information recorded in the recording section 204 of the image capturing apparatus 102 are output to the playback device 103 via the above-described recording medium and network. In other words, in the playback device 103, the controller 601 acquires the video signal and haptic information recorded in the recording section 204 of the image capturing apparatus 102 from the recording medium I/F 606 or via the communication section 607. Further, upon receipt of an instruction for reproducing video from the operator of the playback device 103 via the operation section 605, the controller 601 controls the communication section 607 to output the video signal to the display device 104 and the haptic information to the haptic device 105.

In doing this, the controller 601 converts the video signal to a form suitable for display on the display device 104 and outputs the converted video signal to the display device 104. Further, the controller 601 converts the haptic information to a form suitable for display on the haptic device 105 and outputs the converted haptic information to the haptic device 105. Thus, the display of the video signal is performed by the display device 104 and presentation of the haptic information is performed by the haptic device 105. This enables the user 106 to experience video when the playback of the video is performed in the video experiencing system 101 and experience pseudo haptic sensation fed back by the haptic device 105.

According to the first embodiment, according to the object precedence information of an object included in the video signal generated by the image capturing apparatus 102, haptic information corresponding to the object is controlled. More specifically, according to a size relationship between objects in each frame of the video signal, the strength of waveform data of haptic information corresponding to an object relatively large in size is increased, or the strength of waveform data of haptic information corresponding to an object relatively small in size is decreased. This causes pseudo haptic sensation which the haptic device 105 feeds back to the user 106 by using haptic information to match the strength of impression given to the user 106 by the video signal, whereby the realism of the video is enhanced. Thus, the image capturing apparatus 102 (controller) is capable of causing the haptic device 105 to feed back the pseudo haptic sensation for enhancing the realism of video.

Note that in the first embodiment, the object precedence information indicates the precedence of each object according to the size relationship of the sizes of objects, for each frame of the video signal generated by the image processor 301, but is not limited to this.

The object precedence information can, for example, indicate the precedence of each object by a long-short relationship between distances from the frame center of the video signal of each object to the object. In this case, in each frame of the video signal, an object, which is long in distance from the frame center, is higher in precedence than an object, which is shorter in distance from the same. Therefore, the controller 206 controls the haptic information controller 305 to increase the amplitude of waveform data of haptic information corresponding to an object relatively short in distance from the frame center of the video signal. Alternatively, the controller 206 controls the haptic information controller 305 to decrease the amplitude of waveform data of haptic information corresponding to an object relatively long in distance from the frame center of the video signal.

Further, the object precedence information can indicate precedence based on whether or not the size of each object exceeds a predetermined threshold value set in advance. In this case, in each frame of the video signal, an object the size of which exceeds a predetermined threshold value is determined to be higher in precedence than an object the size of which does not exceed the predetermined threshold value. Therefore, the controller 206 controls the haptic information controller 305 to increase the amplitude of waveform data of haptic information corresponding to the object the size of which exceeds the predetermined threshold value. Alternatively, the controller 206 controls the haptic information controller 305 to decrease the amplitude of waveform data of haptic information corresponding to the object the size of which does not exceed the predetermined threshold value.

Further, the object precedence information can indicate precedence based on whether or not each object is included in a target area of the auto focus control by the image capturing apparatus 102. In this case, in each frame of the video signal, an object included in the target area of the auto focus control in the image capturing apparatus 102 is determined to be higher in precedence than an object not included the target area of the auto focus control in the image capturing apparatus 102. Therefore, the controller 206 controls the haptic information controller 305 to increase the amplitude of waveform data corresponding to the object included in the target area of the auto focus control of the image capturing apparatus 102. Alternatively, the controller 206 controls the haptic information controller 305 to decrease the amplitude of waveform data corresponding to the object not included in the target area of the auto focus control of the image capturing apparatus 102.

This is also the case when the object precedence information indicates precedence, for example, based on whether or not each object is included in a depth-of-field area of the image capturing apparatus 102.

Further, the object precedence information can indicate precedence, for example, in a case where the aforementioned recording section has a directivity, based on whether or not each object is included in a range of directivity. In this case, in each frame of the video signal, an object included in the range of directivity of the recording section is determined to be higher in precedence than an object not included in the range of directivity of the recording section. Therefore, the controller 206 controls the haptic information controller 305 to increase the amplitude of waveform data of haptic information corresponding to an object included in the range of directivity of the above-described recording section. Alternatively, the controller 206 controls the haptic information controller 305 to decrease the amplitude of waveform data of haptic information corresponding to an object not included in the range of directivity of the above-described recording section.

Further, the object precedence information can indicate precedence, for example, based on whether or not each object is a major object. In this case, in each frame of the video signal, an object which is a major object is determined to be higher in precedence than an object which is not a major object. Therefore, the controller 206 controls the haptic information controller 305 to increase the amplitude of waveform data of haptic information corresponding to an object which is a major object. Alternatively, the controller 206 controls the haptic information controller 305 to decrease the amplitude of waveform data of haptic information corresponding to an object which is not a major object. Note that the controller 206 determines whether or not each object is a major object, by using personal authentication in the image capturing apparatus 102.

Further, the controller 206 can determine whether or not each object is a major object, based on a result of determination of an image capturing scene. For example, if the controller 206 determines that the image capturing scene is a natural scenery scene, in each frame of the video signal, an object having a movement or sound output, such as rain, blowing snow, thunder, waves, a brook, or a living being, is determined to be a major object. Further, the controller 206 controls the haptic information controller 305 to increase the amplitude of waveform data of haptic information corresponding to an object having a movement or sound output, which is determined to be a major object. Alternatively, the controller 206 controls the haptic information controller 305 to decrease the amplitude of waveform data of haptic information corresponding to an object which is determined not to be a major object.

Further, if the controller 206 determines, for example, that the image capturing screen is a sports scene, the controller 206 determines that in each frame of the video signal, a person playing sports is a major object. Further, the controller 206 increases the amplitude of waveform data of haptic information corresponding to movement of the person playing the sports, who is determined to be a major object. Alternatively, the controller 206 decreases the amplitude of waveform data of haptic information corresponding to an object which is determined not to be a major object. Note that, in this case, the controller 206 determines that an object included in a background of the person playing sports is not a major object.

Further, the object precedence information can indicate precedence, for example, based on whether or not each object is so bright as will cause overexposure. In this case, in each frame of the video signal, an object which is so bright as will cause overexposure is an object inconspicuous to the user 106, and hence is determined to be lower in precedence than objects which do not cause overexposure. Therefore, the controller 206 controls the haptic information controller 305 to decrease the amplitude of waveform data of haptic information corresponding to an object which is so bright as will cause overexposure. Alternatively, the controller 206 controls the haptic information controller 305 to increase the amplitude of waveform data of haptic information corresponding to an object which is not so bright as will cause overexposure. Note that the controller 206 determines whether or not each object is so bright as will cause overexposure, by using brightness information of each object and brightness information of an area in which the object is included.

Similarly, the object precedence information can indicate precedence based on whether or not each object is so dark as will cause crushed blacks. In this case, in each frame of the video signal, an object which is so dark as will cause crushed blacks is an object inconspicuous to the user 106, and hence is determined to be lower in precedence than objects which do not cause crushed blacks. Therefore, the controller 206 controls the haptic information controller 305 to decrease the amplitude of waveform data of haptic information corresponding to an object which is so dark as will cause crushed blacks. Alternatively, the controller 206 controls the haptic information controller 305 to increase the amplitude of waveform data of haptic information corresponding to an object which is not so dark as will cause crushed blacks. Note that the controller 206 determines whether or not each object is so dark as will cause crushed blacks, by using brightness information of each object and brightness information of an area in which the object is included.

Further, the object precedence information can indicate precedence, for example, based on a near-far relationship of objects from the image capturing apparatus 102. In this case, in each frame of the video signal, an object which is near from the image capturing apparatus 102 is determined to be higher in precedence than an object which is far from the image capturing apparatus 102. Therefore, the controller 206 controls the haptic information controller 305 to increase the amplitude of waveform data of haptic information corresponding to an object which is near from the image capturing apparatus 102. Alternatively, the controller 206 controls the haptic information controller 305 to decrease the amplitude of waveform data of haptic information corresponding to an object which is far from the image capturing apparatus 102. Note that the controller 206 acquires a distance from the image capturing apparatus 102 to each object by measurement by the ranging section 213.

Further, the object precedence information can indicate precedence, for example, based whether or not each object is a predetermined object. In this case, in each frame of the video signal, an object which is a predetermined object is higher in precedence than an object which is not a predetermined object. Therefore, the controller 206 controls the haptic information controller 305 to increase the amplitude of waveform data of haptic information corresponding to an object which is a predetermined object. Alternatively, the controller 206 controls the haptic information controller 305 to decrease the amplitude of waveform data of haptic information corresponding to an object which is not a predetermined object. Note that the predetermined object can be designated by an operation using the operation section 210 by an operator using the operation section 210, and can be designated according to a mode of the image capturing apparatus 102 set by an operator using the operation section 210.

Further, in the first embodiment, types of objects detected from the video signal as targets from which haptic information is to be generated are concrete entities, such as the fireworks 401 and the fountain 403, but this is not limitative. For example, in a case where image capturing by the image capturing apparatus 102 is performed in a place where wind is blowing strongly, the types of objects detected from the video signal as targets from which haptic information is to be generated can include wind. In this case, in a case where objects included in the video signal, such as trees, are swaying, the controller 206 determines the wind is detected, and further generates waveform data of haptic information corresponding to the wind.

In this case, the object precedence information can indicate, based on a wide-narrow relationship of an area in which objects, such as trees, are swaying by wind. Further, in this case, in each frame of the video signal, an object included in an area where the object is swaying by wind, which area is broader, is determined to be higher in precedence than an object included in an area where the object is swaying by wind, which area is narrower. Therefore, the controller 206 controls the haptic information controller 305 to increase the amplitude of waveform data of haptic information corresponding to the object included in the area where the object is swaying by wind, which area is broader. Alternatively, the controller 206 controls the haptic information controller 305 to decrease the amplitude of waveform data of haptic information corresponding to an object included in the area where the object is swaying by wind, which area is narrower.

Further, in the first embodiment, the control of haptic information, which is performed by the haptic information controller 305, is for increasing or decreasing the amplitude of waveform data of haptic information, this is not limitative. For example, the controller 206 can set the band of frequencies of waveform data of haptic information corresponding to an object higher in precedence as a band of frequencies which can be easily perceived by human beings through the control of haptic information performed by the haptic information controller 305.

Further, in the first embodiment, for example, the controller 206 can record, by referring to the object precedence information, only haptic information corresponding to objects the sizes of which are ranked high, out of the objects included in the video signal.

Further, in the first embodiment, the controller 601 (second control unit) of the playback device 103 can control the method of feeding back pseudo haptic sensation by the haptic device 105. For example, in a case where an area for presenting pseudo haptic sensation is formed by a plurality of partial areas, the controller 601 can perform presentation of pseudo haptic sensation by the haptic device 105, by either a central partial area or a peripheral partial area. Thus, the controller 601 can control the largeness of an area for presenting pseudo haptic sensation by the haptic device 105. Further, in this case, the controller 601 can present, for example, pseudo haptic sensation by using the waveform data of haptic information corresponding to an object higher in precedence, in the central partial area or an area wider than the central partial area of the haptic device 105.

Further, in a case where the number of pieces of haptic information which can be used for presentation of pseudo haptic sensation by the haptic device 105 is limited, the controller 601 (third control unit) of the playback device 103 can be preferentially performed using haptic information corresponding to objects higher in precedence.

Further, in the first embodiment, if the haptic device 105 has the aforementioned temperature presenting device, the controller 206 can increase the temperature of temperature data of haptic information corresponding to an object higher in precedence. Alternatively, the controller 206 can decrease the temperature of temperature data of haptic information corresponding to an object lower in precedence. This makes it possible to given stronger impression of the object higher in precedence to the user 106, by causing the user 106 to sense a specific temperature as the pseudo haptic sensation presented by the haptic device 105.

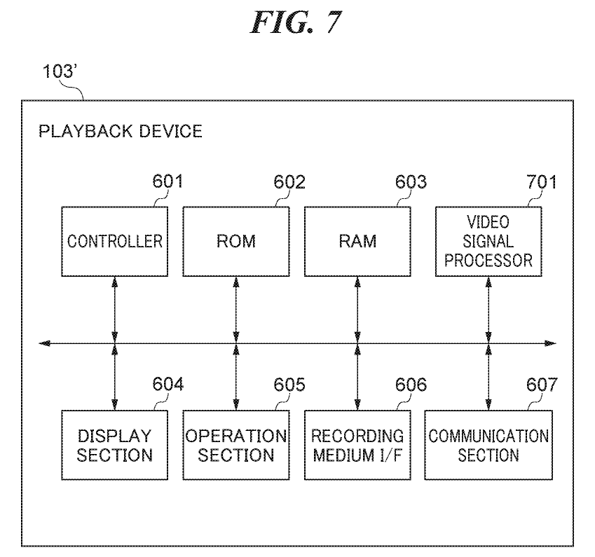

Hereafter, a second embodiment will be described with reference to FIGS. 7-9. In the first embodiment, the case is described in which the generation of haptic information and the control of the haptic information are performed when a video signal is generated in the image capturing apparatus 102. In contrast, a case is described in which the generation of haptic information and the control of the haptic information are performed when video is reproduced (played back). Note that in the second embodiment, differences from the first embodiment will be described. Further, in the second embodiment, the same components of the configuration as those of the first embodiment are denoted by the same reference numerals, whereby redundant description thereof is omitted.

FIG. 7 is a block diagram showing an example of the configuration of a playback device 103’ according to the second embodiment. As shown in FIG. 7, the playback device 103’ includes, a video signal processor 701, in addition to the above-described controller 601, ROM 602, RAM 603, display section 604, operation section 605, recording medium I/F 606, and communication section 607. The video signal processor 701 generates haptic information for objects included in the video signal, on an object-by-object basis, and generates object precedence information for each of the objects included in the video signal. Further, the video signal processor 701 performs control of haptic information according to the object precedence information.

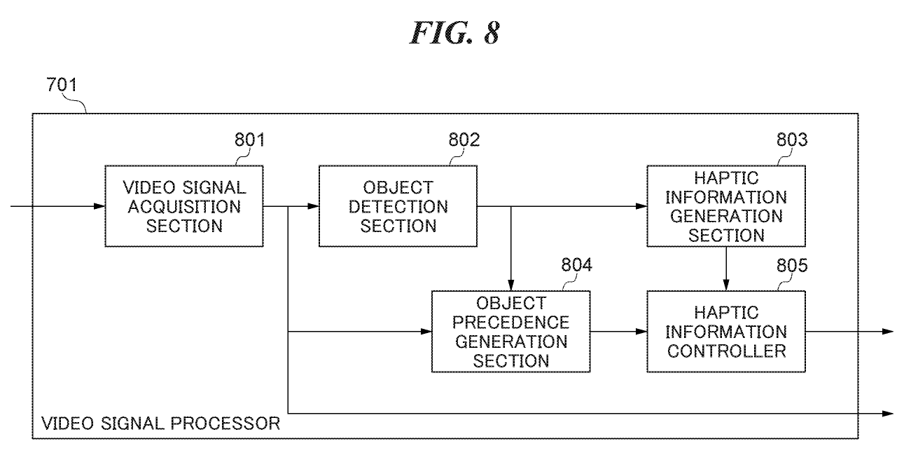

FIG. 8 is a block diagram showing an example of a functional configuration of the video image signal processor 701 of the playback device 103’. The video signal processor 701 includes a video signal acquisition section 801, an object detection section 802, a haptic information generation section 803, an object precedence generation section 804, and a haptic information controller 805. The video signal acquisition section 801 acquires the video signal via the aforementioned recording medium or network. The video signal acquired by the video signal acquisition section 801 is output to the display device 104, and is output to the object detection section 302 and the object precedence generation section 304.

Note that the object detection section 802, the haptic information generation section 803, the object precedence generation section 804, and the haptic information controller 805 are the same as the object detection section 302, the haptic information generation section 303, the object precedence generation section 304, and the haptic information controller 305. Therefore, detailed descriptions of the object detection section 802, the haptic information generation section 803, the object precedence generation section 804, and the haptic information controller 805 are omitted. However, the haptic information controlled by the haptic information controller 805 is output to the haptic device 105.

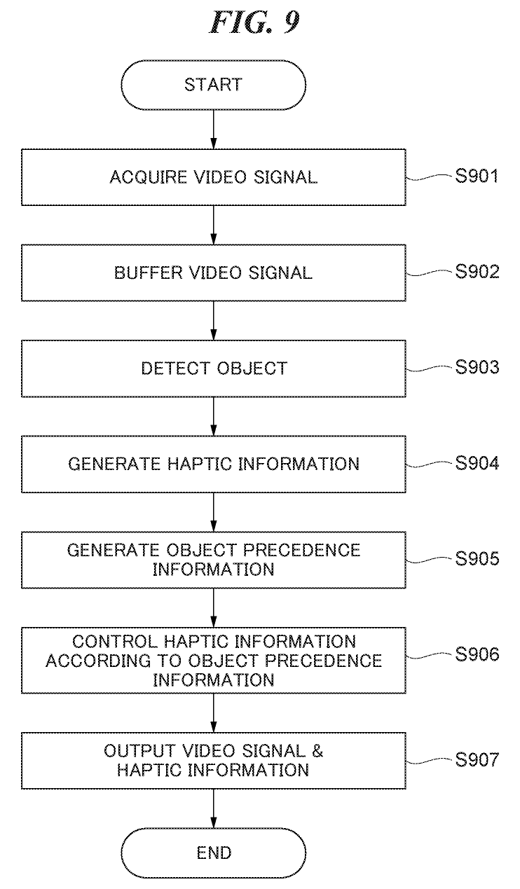

Next, the operation of the playback device 103’ will be described. FIG. 9 is a flowchart of the control process for controlling the operation of the playback device 103’. The control process (control method of the control device) in FIG. 9 is realized by the controller 601 of the playback device 103’, loading a program stored in the ROM 602 into the RAM 603 and executing the loaded program. Upon reception of an inspection for reproducing video from an operator of the playback device 103’, via the operation section 605, the controller 601 starts the control process in FIG. 9.

When the control process in FIG. 9 is started, the controller 206 acquires the video signal by the video signal acquisition section 801 and the like, in a step S901. Thereafter, the controller 601 (storage unit, first generation unit, second generation unit, first control unit) executes processing in steps S902 to S906 (first generation, second generation, control). Processing in each of the steps S902 to S906 is the same as processing in each of the steps S502 to 506. Therefore, detailed descriptions of each processing in the steps S902 to 906 is omitted.

In a step S907, the controller 601 (output unit) controls the communication section 607 to output the video signal to the display device 104 and the haptic information to the haptic device 105. In doing this, the controller 601 converts the video signal to a form suitable for display on the display device 104, and the converted video signal is output to the display device 104. Further, after converting the haptic information to a form suitable for presentation by the haptic device 105, the controller 601 outputs the converted haptic information to the haptic device 105. This causes the display of the video signal to be executed on the display device 104, and the presentation of haptic information to be executed by the haptic device 105, followed by terminating the control process in FIG. 9.

As described heretofore, according to the second embodiment, when video is reproduced (played back), haptic information is generated for each of the objects included in the video signal, and object precedence information is generated for each frame of the video signal. Further, the control of the haptic information is performed according to the object precedence information. This enables, even the haptic information is not added to the video signal displayed on the display device 104, the user 106 to experience pseudo haptic sensation fed back by the haptic device 105 so that the realism of video is enhanced. Thus, the playback device 103’ (control device, playback device) is capable of causing the haptic device 105 to feed back pseudo haptic sensation intended for enhancing the realism of the video.

The preferred embodiments of the present disclosure have been described heretofore, but the present disclosure is not limited to the embodiments, and can be modified and changed within the scope of the subject matter. For example, in each of the embodiments, generation of haptic information and generation of object precedence information can be executed before editing the video signal buffered in the RAM 208 or the RAM 603. In doing this, the video generated by editing the video signal can be not only video in the normal form of video formed by a moving image or still images, but also e.g. video in an XR format. Note that extended reality (XR) is a technique of realizing fusion of reality and virtuality, and is a generic name for virtual reality (VR), augmented reality (AR), mixed reality (MR), and substitutional reality (SR). In short, the format of video can be any format, insofar as it is a format which allows hepatic information and object precedence information to be generated from the video signal.

According to the present disclosure, it is possible to cause a haptic device to feed back pseudo haptic sensation for enhancing realism of video.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-066835, filed April 15, 2025, which is hereby incorporated by reference herein in its entirety.

What is claimed is:

1. A control device that in a case where a first object and a second object which higher in precedence than the first object are included in a frame of a video signal, makes pseudo haptic sensation fed back to a user according to the second object stronger than pseudo haptic sensation fed back to the user according to the first object.

2. The control device according to claim 1, wherein the precedence is indicated based on a size relationship of objects in the frame of the video signal.

3. The control device according to claim 1, wherein the precedence is indicated based on a long-short relationship between distances from a frame center of the video signal to objects.

4. The control device according to claim 1, wherein the precedence is indicated based on whether or not a size of each of objects in the frame of the video signal exceeds a predetermined threshold value.

5. The control device according to claim 1, wherein the precedence is indicated based on whether or not each of objects in the frame of the video signal is included in a target area of auto focus control performed when image data as a source of the video signal is acquired.

6. The control device according to claim 1, wherein the precedence is indicated based on whether or not each of objects in the frame of the video signal is included in a depth-of-field area when image data as a source of the video signal is acquired.

7. The control device according to claim 1, wherein the precedence is indicated based on whether or not each of objects in the frame of the video signal is included in a range of directivity of sound recording performed when image data as a source of the video signal is acquired.

8. The control device according to claim 1, wherein the precedence is indicated based on whether or not each of objects in the frame of the video signal has a brightness that causes overexposure or crushed blacks.

9. The control device according to claim 1, wherein the precedence is indicated based on a near-far relationship of respective distances of objects in each frame of the video signal, which are measured when image data as a source of the video signal is acquired.

10. The control device according to claim 1, wherein the precedence is indicated based on whether or not each of objects in the frame of the video signal is a major object.

11. The control device according to claim 10, wherein the major object is a person personally authenticated.

12. The control device according to claim 10, wherein in a case where the frame of the video signal is a scenery scene, the major object is an object which moves.

13. The control device according to claim 10, wherein in a case where the frame of the video signal is a sports scene, the major object is a person playing sports.

14. The control device according to claim 1, wherein the precedence is indicated based on whether or not each of objects in the frame of the video signal is a predetermined object.

15. A control device including:
at least one processor; and
a memory storing instructions that, when executed by the at least one processor, causes the at least one processor to function as:
a first generation unit configured to generate haptic information used when a haptic device feeds back pseudo haptic sensation to a user, for each of objects included in the video signal;
a second generation unit configured to generate object precedence information indicating precedence of each of the objects included in the video signal, for each frame of the video signal; and
a first control unit configured to control haptic information generated by the first generation unit according to object precedence information generated by the second generation unit,
wherein the first control unit makes pseudo hepatic sensation fed back to a user by the haptic device by using haptic information corresponding to a second object higher in precedence than a first object stronger than pseudo hepatic sensation fed back to the user by the haptic device by using haptic information corresponding to the first object.

16. The control device according to claim 15, wherein the haptic information controlled by the first control unit is waveform data for presenting pseudo haptic sensation by vibrations caused by the haptic device, a feature amount of the waveform data, or a band of frequencies of the waveform data.

17. The control device according to claim 15, wherein haptic information controlled by the first control unit is temperature data for the haptic device to present pseudo haptic sensation by temperature.

18. The control device according to claim 15, further including a storage unit that buffers the video signal, and
wherein the first generation unit and the second generation unit generate haptic information and object precedence information by using the video signal buffered in the storage unit.

19. The control device according to claim 18, wherein the first generation unit and the second generation unit generate haptic information and object precedence information when the video signal buffered in the storage unit is edited.

20. The control device according to claim 18, wherein the first generation unit and the second generation unit generate haptic information and object precedence information when a video in an XR format is generated by using the video signal buffered in the storage unit.

21. The control device according to claim 15, wherein the precedence is indicated based on a size relationship of objects in the frame of the video signal.

22. The control device according to claim 15, wherein the precedence is indicated based on a long-short relationship between distances from a frame center of the video signal to objects.

23. The control device according to claim 15, wherein the precedence is indicated based on whether or not a size of each of objects in the frame of the video signal exceeds a predetermined threshold value.

24. The control device according to claim 15, wherein the precedence is indicated based on whether or not each of objects in the frame of the video signal is included in a target area of auto focus control performed when image data as a source of the video signal is acquired.

25. The control device according to claim 15, wherein the precedence is indicated based on whether or not each of objects in the frame of the video signal is included in a depth-of-field area when image data as a source of the video signal is acquired.

26. The control device according to claim 15, wherein the precedence is indicated based on whether or not each of objects in the frame of the video signal is included in a range of directivity of sound recording performed when image data as a source of the video signal is acquired.

27. The control device according to claim 15, wherein the precedence is indicated based on whether or not each of objects in the frame of the video signal has a brightness that causes overexposure or crushed blacks.

28. The control device according to claim 15, wherein the precedence is indicated based on a near-far relationship of respective distances of objects in each frame of the video signal, which are measured when image data as a source of the video signal is acquired.

29. The control device according to claim 15, wherein the precedence is indicated based on whether or not each of objects in the frame of the video signal is a major object.

30. The control device according to claim 29, wherein the major object is a person personally authenticated.

31. The control device according to claim 29, wherein in a case where the frame of the video signal is a scenery scene, the major object is an object which moves.

32. The control device according to claim 29, wherein in a case where the frame of the video signal is a sports scene, the major object is a person playing sports.

33. The control device according to claim 15, wherein the precedence is indicated based on whether or not each of objects in the frame of the video signal is a predetermined object.

34. A playback device comprising:
a control device including:
at least one processor; and
a memory storing instructions that, when executed by the at least one processor, causes the at least one processor to function as:
a first generation unit configured to generate haptic information used when a haptic device feeds back pseudo haptic sensation to a user, for each of objects included in the video signal,
a second generation unit configured to generate object precedence information indicating precedence of each of the objects included in the video signal, for each frame of the video signal, and
a first control unit configured to control haptic information generated by the first generation unit according to object precedence information generated by the second generation unit,
wherein the first control unit makes pseudo hepatic sensation fed back to a user by the haptic device by using haptic information corresponding to a second object higher in precedence than a first object stronger than pseudo hepatic sensation fed back to the user by the haptic device by using haptic information corresponding to the first object; and
an output unit configured to output the video signal to a display device, and output haptic information controlled by the first control unit to the haptic device.

35. The playback device according to claim 34, further comprising a second control unit configured to control, in a case where an area presented by pseudo haptic sensation by using the haptic device is formed by a plurality of partial areas, an area presented by pseudo haptic sensation caused by the haptic device, according to object precedence information generated by the second generation unit.

36. The playback device according to claim 34, further comprising a third control unit configured to control, in a case where the number of pieces of haptic information used for the haptic device to feed back pseudo haptic sensation to the user, presentation of pseudo haptic sensation by the haptic device by preferentially using haptic information corresponding to an object which is higher in the precedence.

37. An image capturing apparatus comprising:
a control device including:
at least one processor; and
a memory storing instructions that, when executed by the at least one processor, causes the at least one processor to function as:
a first generation unit configured to generate haptic information used when a haptic device feeds back pseudo haptic sensation to a user, for each of objects included in the video signal,
a second generation unit configured to generate object precedence information indicating precedence of each of the objects included in the video signal, for each frame of the video signal; and
a first control unit configured to control haptic information generated by the first generation unit according to object precedence information generated by the second generation unit,
wherein the first control unit makes pseudo hepatic sensation fed back to a user by the haptic device by using haptic information corresponding to a second object higher in precedence than a first object stronger than pseudo hepatic sensation fed back to the user by the haptic device by using haptic information corresponding to the first object; and
a generation unit configured to generate the video signal.

38. The image capturing apparatus according to claim 37, further comprising a recording unit configured to record haptic information controlled by the first control unit, in a state added to the video signal.

39. The image capturing apparatus according to claim 37, wherein the recording unit records only haptic information corresponding to only haptic information corresponding to objects included in the video signal, which are ranked high, in a state added to the video signal.

40. A method controlling a control device, comprising:
generating haptic information used when a haptic device feeds back pseudo haptic sensation to a user, for each of objects included in the video signal;
generating object precedence information indicating precedence of each of the objects included in the video signal, for each frame of the video signal; and
controlling haptic information generated by the generating mentioned first according to object precedence information generated by the generating mentioned second,
wherein the controlling includes making pseudo hepatic sensation fed back to a user by the haptic device by using haptic information corresponding to a second object higher in precedence than a first object stronger than pseudo hepatic sensation fed back to the user by the haptic device by using haptic information corresponding to the first object.

41. A non-transitory computer-readable storage medium storing a program for causing a computer to execute a method of controlling a control device,
wherein the control method comprises:
generating haptic information used when a haptic device feeds back pseudo haptic sensation to a user, for each of objects included in the video signal;
generating object precedence information indicating precedence of each of the objects included in the video signal, for each frame of the video signal; and
controlling haptic information generated by the generating mentioned first according to object precedence information generated by the generating mentioned second,
wherein the controlling includes making pseudo hepatic sensation fed back to a user by the haptic device by using haptic information corresponding to a second object higher in precedence than a first object stronger than pseudo hepatic sensation fed back to the user by the haptic device by using haptic information corresponding to the first object.
